(19) United States
(12) Patent Application Publication
(10) Pub. No.: US 2021/0286659 A1
(43) Pub. Date: Sep. 16, 2021

(54) PACKET-BASED MULTICAST COMMUNICATION SYSTEM

(71) Applicant: Siemens Healthcare GmbH, Erlangen (DE)

(72) Inventors: Stefan ASSMUS, Wilhermsdorf (DE); Harald KARL, Fuerth (DE); Torsten KOENIG, Erlangen (DE); Andreas WESTERKOWSKY, Nuernberg (DE)

(73) Assignee: Siemens Healthcare GmbH, Erlangen (DE)

(21) Appl. No.: 17/197,214

(22) Filed: Mar. 10, 2021

(30) Foreign Application Priority Data
Mar. 11, 2020 (DE) 10 2020 203 113.4

(51) Int. Cl. G06F 9/54; G06F 13/40; G05B 19/042

(52) U.S. Cl. CPC G06F 9/542; G05B 2219/2652; G05B 19/0426; G06F 13/4027

(57) ABSTRACT

An integrated chip-based communication system is described. The integrated chip-based communication system includes a plurality of source ports and destination ports; and a crossbar or an interconnect. In an embodiment, the crossbar or the interconnect is configured, based upon an address matrix of an address header of a data packet received from one of the source ports, to ascertain one or more destination ports as receivers of the data packet; to transmit the data packet to the ascertained receivers; and to ascertain a readiness to receive of at least one of the receivers and design the data transfer as a function of the ascertained readiness to receive. A medical imaging facility is also described. Furthermore, a data transfer method for transferring data packets is described.

### PRIORITY STATEMENT

The present application hereby claims priority under 35 U.S.C. § 119 to German patent application number DE 102020203113.4 filed Mar. 11, 2020, the entire contents of which are hereby incorporated herein by reference.

### FIELD

Example embodiments of the invention generally relate to an integrated chip-based communication system. Furthermore, example embodiments of the invention relates to a medical imaging facility. The invention also relates to a data transfer method for transferring data packets.

### BACKGROUND

When designing FPGA/ASIC-based hardware, industrial standard protocols such as AHB, AXI4, Wishbone, Avalon, etc. are usually used for on-chip communication. These protocols offer multiple configuration options. One configuration option involves what is known as memory-mapped communication, in which the participants are all assigned to one address space and it is then possible for data to be written into a memory/register or the like based upon a target address. In another configuration option, in AXI4 for example, what is known as a streaming mode can be configured, in which a transmitter always transmits to a particular receiver, without an addressing method being used. The modes are configured, however, and it is possible to implement either one method or the other. It is not possible to make a packet-based decision as to which kind of communication is to be used in this context. Thus, in a streaming communication for example, it is not possible to transfer a configuration. The simultaneous transmission of a data stream to a plurality of participants is also not provided in the protocol. There are extensions in the form of an intermediate switch matrix, but this always realizes a 1-to-N relationship with fixed parameterization. Hence, packet-based multicast is not possible.

Previously, if there has been a need for communication with streaming data for configuration, then a second interface has been implemented, such as an address data bus for example. This results in different runtimes for the different communication methods. If the configuration is to be modified within an ongoing data stream, then the actuated module independently has to pay attention to whether it is able to implement the configuration immediately or has to wait for a data pause, for example. Packet-based multicast is consequently possible without a protocol and without an extension. For this reason, what is known as daisy chaining is conventionally used, in which a receiver passes on the packet once more to the next participant following receipt.

### SUMMARY

The inventors discovered that, although realizations via ring buffers are able to implement multicast with a plurality of participants, they do not support backpressing, i.e. if a participant is unable to accept the packet, it is inevitably lost and has to be skipped or requested again. In this context, other addressees have to be notified that the packet that has already been accepted has to be discarded. The administration is therefore considerably more complex.

At least one embodiment of the present application is directed to developing a more flexible on-chip communication, which also enables what is known as multicast data transfer.

Embodiments of the present application are directed to an integrated chip-based communication system, a medical imaging facility as well as by a data transfer method.

The integrated chip-based communication system according to an embodiment of the invention has a plurality of source ports and destination ports and a crossbar or an interconnect. The crossbar or the interconnect is configured, based upon an address matrix of an address header of a data packet received from one of the source ports, to ascertain one or more destination ports as receivers of the data packet and to transmit the data packet to the ascertained receivers. By way of the definition of address headers in packets, to which a matrix of destination ports is allocated, it is possible to decide, in a packet-based manner, whether the destination ports to be actuated involve a single destination port or a plurality of destination ports. With the aid of the crossbar or the interconnect, it is thus possible to decide, in a packet-based manner, which destination ports are actuated.

The medical imaging facility according to an embodiment of the invention has a scanning unit for the acquisition of raw data of a patient, a control facility for actuating the scanning unit and the integrated chip-based communication system according to the invention. The medical imaging facility may involve a magnetic resonance tomography system or a computed tomography system, for example.

In the data transfer method according to an embodiment of the invention for transferring data packets between a plurality of source ports and destination ports by means of a crossbar or an interconnect, based upon an address matrix of an address header of a data packet received from one of the source ports, one or more destination ports are ascertained as receivers of the data packet and the data packet is transmitted to the ascertained receivers. In addition, a readiness to receive of at least one of the receivers is ascertained and the data transfer is designed as a function of the ascertained readiness to receive. The data transfer method according to the invention shares the advantages of the integrated chip-based communication system.

At least one embodiment further relates to an integrated chip-based communication system, comprising:

a plurality of source ports and a plurality of destination ports; and

a crossbar or an interconnect, configured to
ascertain, based upon an address matrix of an address header of a data packet received from one of the plurality of source ports, one or more destination ports as receivers of the data packet and transmit the data packet to the receivers ascertained, and
ascertain a readiness to receive at least one of the receivers and design data transfer as a function of the readiness to receive ascertained.

At least one embodiment further relates to a medical imaging facility, comprising:

a scanning device to acquire raw data of a patient;

a control facility to actuate the scanning device; and

the integrated chip-based communication system of an embodiment.

At least one embodiment further relates to a data transfer method for transferring data packets between a plurality of source ports and a plurality of destination ports via a crossbar or an interconnect, the data transfer method comprising:

ascertaining, based upon an address matrix of an address header of a data packet received from one of the source ports of the plurality of source ports, one or more destination ports of the a plurality of destination ports, as receivers of the data packet; and
transmitting the data packet to the receivers ascertained; and
ascertaining a readiness to receive of at least one of the receivers; and
designing data transfer as a function of the readiness to receive ascertained.

### BRIEF DESCRIPTION OF THE DRAWINGS

The invention is explained again in more detail below with reference to the appended figures based upon example embodiments. In the various figures, the same components are identified with identical reference signs.

The figures are in general not to scale. In the drawings:

FIG. 1 shows a schematic example embodiment of a conventional on-chip data transfer system,

FIG. 2 shows a schematic representation of a packet-based on-chip data transfer system in accordance with an example embodiment of the invention,

FIG. 3 shows a schematic representation of a packet-based on-chip data transfer system in accordance with an example embodiment of the invention,

FIG. 4 shows a schematic block diagram of a crossbar in accordance with an example embodiment of the invention,

FIG. 5 shows a schematic representation of a data transfer system of a CT system according to the invention,

FIG. 6 shows a magnetic resonance tomography system in accordance with an example embodiment of the invention.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. At least one embodiment of the present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

The integrated chip-based communication system according to an embodiment of the invention has a plurality of source ports and destination ports and a crossbar or an interconnect. The crossbar or the interconnect is configured, based upon an address matrix of an address header of a data packet received from one of the source ports, to ascertain one or more destination ports as receivers of the data packet and to transmit the data packet to the ascertained receivers. By way of the definition of address headers in packets, to which a matrix of destination ports is allocated, it is possible to decide, in a packet-based manner, whether the destination ports to be actuated involve a single destination port or a plurality of destination ports. With the aid of the crossbar or the interconnect, it is thus possible to decide, in a packet-based manner, which destination ports are actuated.

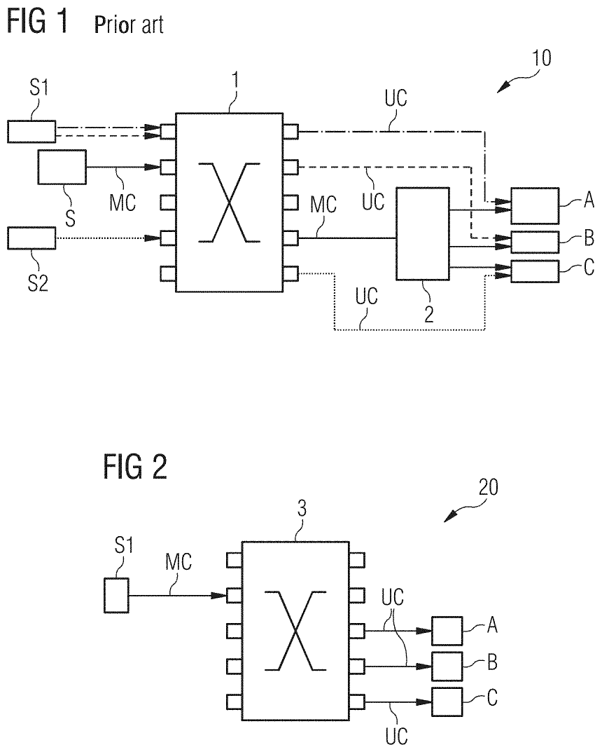

Furthermore, in an embodiment, the crossbar or the interconnect is configured to ascertain a readiness to receive of at least one of the receivers and to design the data transfer as a function of the ascertained readiness to receive. Advantageously, with the integrated chip-based communication system according to an embodiment of the invention, it is possible for what is known as multicast communication to be implemented, wherein a data packet reaches a plurality of receivers at exactly the same point in time. In particular, it is possible to realize real-time communication which is insensitive to large and varying latencies. For example, this makes it possible to realize what are known as multicast image transfers or trigger events. Moreover, there is no need for an additional configuration interface for switching between a streaming mode and memory-mapped communication. An additional extension in the form of an intermediate switch matrix is also not required, as illustrated in FIG. 1 for example.

The medical imaging facility according to an embodiment of the invention has a scanning unit for the acquisition of raw data of a patient, a control facility for actuating the scanning unit and the integrated chip-based communication system according to the invention. The medical imaging facility may involve a magnetic resonance tomography system or a computed tomography system, for example.

Advantageously, with the chip-based communication system according to the invention, it is possible to realize a synchronous actuation of individual subunits of a scanning unit of a medical imaging facility. For example, in the case of a magnetic resonance tomography system, individual coils can be actuated synchronously with one another. It is also possible to realize a synchronous image display of an image recording in different rooms.

In the case of a computed tomography system, detector elements can be actuated simultaneously, even if different latency times occur when actuating the detector elements.

In the data transfer method according to an embodiment of the invention for transferring data packets between a plurality of source ports and destination ports by means of a crossbar or an interconnect, based upon an address matrix of an address header of a data packet received from one of the source ports, one or more destination ports are ascertained as receivers of the data packet and the data packet is transmitted to the ascertained receivers. In addition, a readiness to receive of at least one of the receivers is ascertained and the data transfer is designed as a function of the ascertained readiness to receive. The data transfer method according to the invention shares the advantages of the integrated chip-based communication system.

Further, particularly advantageous embodiments and developments of the invention are given in the dependent claims and in the following description, where the claims in one category of claims can also be developed in a similar way to the claims and passages of the description in another category of claims, and in particular individual features of different example embodiments or variants can also be combined to create new example embodiments or variants.

In one variant of the integrated chip-based communication system according to the invention, the crossbar or the interconnect is configured to design the data transfer as a function of the ascertained readiness to receive, such that in the event that a destination port is not ready to receive, the transfer of the received data packet to the destination port is suspended.

If the transfer of the received data packet to the destination ports that are ready to receive is continued, then it is advantageously possible to achieve an instantaneous data transmission for the remaining destination ports that is synchronous in time, which is necessary for example in the case of multicast processes running in real time.

In one embodiment of the integrated chip-based communication system according to the invention, the crossbar or the interconnect is configured to also suspend the transfer of the received data packet to the destination ports that are ready to receive, and to only resume the transfer when all destination ports are ready to receive again. Advantageously, a synchronous data transfer to all destination ports can be achieved. In the event of congestion at a destination port, no data is lost, but rather it accumulates and all data arrives at all destination ports in a synchronized and simultaneous manner. The fact that all data is retained enables efficient troubleshooting in particular.

In one variant of the integrated chip-based communication system, the crossbar or the interconnect is configured to transmit a data packet to a plurality of destination ports simultaneously in real-time communication. Advantageously, a synchronous data transfer is enabled, which for example is necessary in a multicast image transfer or in the case of a computed tomography system in the realization of trigger events for a plurality of addressees.

FIG. 1 shows a conventional chip arrangement 10 for on-chip data transfer. The chip arrangement 10 comprises a plurality of sources S, S1, S2, which transmit data to receivers A, B, C. The data is relayed with the aid of a crossbar 1 and a splitter unit 2. The arrangement 10 shown in FIG. 1 can be operated both in multicast operation MC and in unicast operation UC. In multicast operation MC (symbolized by arrows with solid line), data from a transmitter S is first transferred to the crossbar 1, for example. From the crossbar 1, the data is transmitted to the splitter unit 2, which then distributes the data to three different receivers A, B, C in each case. Unicast operation is also possible. For example, data is then transmitted with the aid of the crossbar 1 from a transmitter S1 directly to a receiver A, without using the splitter unit 2 (symbolized by arrow with alternating dashed and dotted line). At the same time, it is also possible for data to be transmitted in unicast mode UC from a transmitter S2 to a receiver C via the crossbar 1 (symbolized by arrow with dotted line). Following the transmission to the receiver A, data is transmitted in unicast mode UC from the transmitter S1 to the receiver B (symbolized by arrow with dashed line).

FIG. 2 illustrates a schematic representation of a packet-based on-chip data transfer system 20 in accordance with an example embodiment of the invention. Unlike in the conventional arrangement 10, a multicast data transfer takes place solely with the aid of a crossbar 3. In this context, the transfer takes place with the aid of a packet-oriented data protocol. The data packets have address information in their header. The address data is read from the header of the respective data packet by the crossbar and the data packets are transmitted to the allocated receivers A, B, C according to the address read. A splitter unit 2 as in FIG. 1 is not necessary.

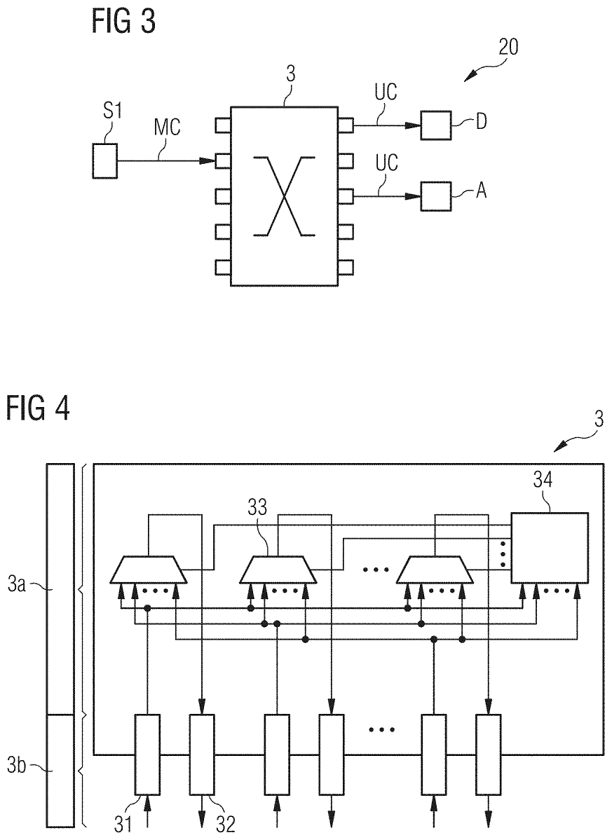

In the arrangement 20 illustrated in FIG. 3, the crossbar 3 already shown in FIG. 2 is shown once again. Here, the data packets are likewise transmitted in the multicast method MC, at least partially to different receivers D than in FIG. 2. For this purpose, the data packets are transmitted by the crossbar 3, according to the received addresses, to the receivers A, D allocated to the addresses.

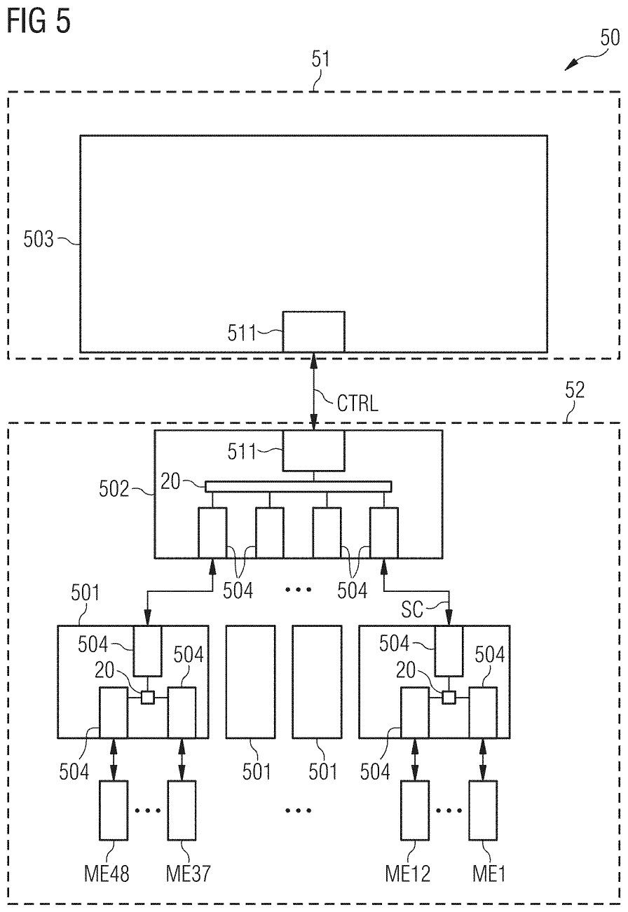

In FIG. 4, a crossbar 3 is shown in accordance with an example embodiment of the invention. For example, the crossbar may be installed in a magnetic resonance tomography system or in a computed tomography system.

A computed tomography system has a large number of modular detector parts, with which raw data of an examination object (not shown) is acquired. One application of the crossbar 3 according to the invention consists in transmitting instructions to the detectors simultaneously in the multicast method and in so doing activating a large number of detector modules simultaneously.

In this embodiment, the crossbar 3 comprises the actual crossbar 3a as well as a submodule 3b connected upstream. The submodule 3b comprises inputs 31 and outputs 32, at which, in accordance with this specific example embodiment, accumulating data is buffered in a queue until it is able to be relayed further to the corresponding outputs by the circuit arrangement 3 designed as crossbar. The modules used for this purpose are for example embodied as what are known as FIFO memories (FIFO=first in first out). The data which has arrived first is therefore also forwarded first. The actual circuit arrangement or the crossbar 3a comprises multiplexer units 33 which interconnect the inputs and outputs 31, 32 in accordance with particular priority rules. In this context, in the case of the specific example embodiment, each input 31 can be connected to each output 32 and vice versa. The decision as to which input 31 is connected to which output 32 in accordance with which priority is made by an arbiter 34, what is known as an arbitration circuit. For example, this may control the multiplexer circuits or multiplexer units 33 in accordance with rigidly defined priorities. They may also, however, allocate dynamically changing priorities for the inputs and outputs. The interconnections may be controlled based upon the information contained in the data structures, particularly the headers of the transferred data packets.

The crossbar 3 enables the use of a kind of bus system, with which the information and data from the communication interfaces can be bundled in a common bus system. This manages to uncouple the physical interfaces from the logical function.

In a CT system, what are known as printed circuit boards are installed as detector circuits in a scanning unit (see FIG. 5). In addition, there are master circuits that interconnect the individual printed circuit boards or detector circuits.

In FPGAs of the printed circuit boards, also referred to as DSC (data stream collector, data stream collector circuit) in the following, as well as in a master circuit DSM (data stream master circuit, data stream master) connected to the parts DSC, a circuit arrangement 20 is realized which comprises a crossbar or a switch 3. Only at this circuit arrangement 3 are all the functional units of the printed circuit boards connected. This circuit arrangement 3 is a central element which equally can be used in the development, for integration, in manufacturing, in clinical application and for diagnostics in a CT system.

All functional blocks in the system advantageously possess the same communication interface, for example, which makes it easier to add new functions and enables a modular system. Thus, each functional block is able to communicate with every other functional block.

In order to improve the observability of the system, it is furthermore possible to integrate a functional block, with the aid of which the bus system is connected to a standard PC interface (Ethernet) for example. As a result, an elimination of complexities is achieved by dividing the functions into individual functional blocks and by introducing a bus system.

As already mentioned, controllable temporal dependencies arise in the system (blocking, data items cannot overtake one another in the system). This creates simple interfaces with low susceptibility to error between the individual boards. Blocking is necessary as all the functional blocks or transfer paths operate at different speeds. It ensures the flexibility required during the data transfer. Within the crossbar 3, FIFO is implemented at each input and output of a port. With this asynchronous FIFO, not only is a clock domain crossing possible, but likewise it also makes it possible to implement the blocking. Through the evaluation “FIFO almost full=not ready”, it can be signaled to the “source”, the transmitter, that the “destination”, the memory of the receiver, could soon become full. Thus, there is still a certain amount of time before the “source” has to adjust its data transmission. Once the “ready” is set (i.e. no longer almost full), it is once again permitted to write at full speed.

From an access to the bus system it is possible to control and optionally observe each individual functional block. This creates a possibility for observing the information or the image data, status data etc. in the system. As already mentioned, real-time communication in particular can be realized without elaborate synchronization.

FIG. 5 schematically shows the structure of an embodiment of a CT system 50 with a data transfer system for the detector data and control data or status data. The system 50 has a control facility 51 and a scanning unit 52.

The control facility 51 comprises a terminal 503, in this example embodiment a PC. The terminal 503 is connected to the scanning unit 52 via an interface 511 for transferring control data CTRL and for receiving raw data of an examination object. The scanning unit 52 comprises a plurality of detectors or module electronics ME1, . . . , ME48 comprised thereby, data stream collectors DSC 501 allocated to each group of module electronics (the term DSC-PCBA=electronic data stream collector board is also used in the following) and a digital data stream master DSM 502 (the term DSM-PCBA=electronic data stream master board is also used in the following). The electronic DSM board DSM-PCBA 502 of the control facility 51 also has a plurality of serial interfaces SERIAL DATA 504 for transferring serial data to the data stream collectors 501.

The data from the DSM-PCBA 502 of the scanning unit 52 is accepted by the DSC-PCBAs 501 of the scanning unit 52 via serial data interfaces 504 and is forwarded to the individual detector elements or module electronics ME 1 to ME 48. Conversely, data from the detector elements ME1, . . . , ME48 or the DSCs 501 of the scanning unit 52 is also sent to the DSM 502 of the scanning unit 52 via the serial interfaces 504, where it is either sent to further DSCs 501 or sent back to the PC 503 of the control facility 51.

The master circuit DSM 502 of the scanning unit 52 also comprises a communication circuit 20 according to the invention, which controls the data streams between the DSCs 501 of the scanning unit 52 and the PC 503 of the control facility 51. In particular, with the aid of the communication circuit 20 according to the invention, it is possible to achieve real-time communication between the control facility 51 and parts of the scanning unit 52, which is insensitive to varying latencies. For example, it is possible to achieve transferring control commands to a large number of detector elements ME1, . . . , ME48 at exactly the same time, whereby an improved image quality of the CT system can be achieved.

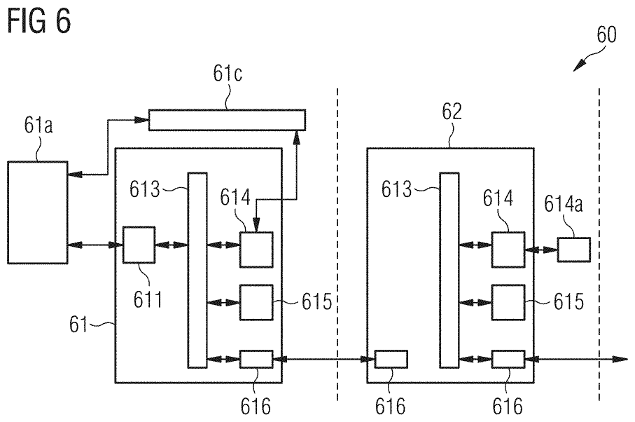

FIG. 6 describes a magnetic resonance tomography system 60, MR system for short, in accordance with an example embodiment of the invention. The MR system 60 comprises a plurality of image display units 614a (with only one image display unit shown, however) in different rooms, wherein the spatial separation is indicated in FIG. 6 by a dashed vertical line in the center of the image and at the right-hand edge of FIG. 6. For example, an image display unit 614a is located directly at a scanning unit (not shown) of the MR system 60 in the examination room shown on the right-hand side of the image in FIG. 6.

In addition, the MR system 60 also has a technical room shown on the left-hand side of the image, in which a computer unit 61c for controlling the MR system 60 is accommodated. The computer unit 61c is connected to a microcontroller 61a via a USB data transfer interface. The microcontroller communicates with a master unit 61 located in the technical room via an Ethernet interface 611. For communication between the computer unit 61c and the image display units 614a positioned outside the technical room, the MR system 60 comprises a master-slave system 61, 62 with the aforementioned master unit 61 and a plurality of slave units 62, of which only one slave unit 62 is shown in FIG. 6 for the sake of clarity.

One of the slave units 62 is located in an examination room for example, in which the scanning unit of the MR system 60 is arranged, and a further slave unit is located in an observation room for example, in which the operating personnel of the MR system stay during the imaging.

The aforementioned computer unit 61c is also directly connected to the master unit 61 via an image data interface 614, in order to transfer image data to the master unit 61.

The master unit 61 also comprises a memory 615 and an HSSL interface 616 for transmitting image data to the slave units 62, of which only one slave unit 62 is shown in FIG. 6. The individual subunits 611, 614, 615, 616 of the master unit 61 are interconnected via a crossbar 613 according to the invention. The slave unit 62 likewise comprises such a crossbar 613, to which a display interface 614, a data memory 615 and two HSSL interfaces 616 (HSSL=high speed serial link) for transferring image data are connected in a similar manner to the master unit 61. A further slave unit 62 (not shown) can be connected to the master-slave system via the right-hand HSSL interface of the slave unit 62 shown in FIG. 6.

If image data to be displayed is now generated by the computer 61c, then it can be forwarded to the slave unit 62 shown in the right-hand half of the image in FIG. 6 via the master unit 61. In the slave unit 62, via a crossbar 613 according to the invention, the image data is passed on to the image data interface 614, from which it is passed on to the image display unit 614a. In this manner, image data can be represented simultaneously in different rooms. Medical personnel can also in turn make inputs via the screen display 614a, which is embodied as a touchscreen for example. These commands can be transmitted via the slave unit 62 to the master unit 61, from which they are forwarded to the computer unit 61c of the MR system 60 via the microcontroller 61a. The respective crossbars 613 are able to decide, in a packet-based manner, which destinations are actuated in each case, so that the data transfer can be restricted to predetermined destinations and image data can be displayed on different image displays 614a at the same time.

Finally, it should again be noted that the devices and methods described above in detail are merely example embodiments which can be modified by a person skilled in the art in a wide variety of ways without departing from the scope of the invention. Furthermore, the use of the indefinite article “a” or “an” does not preclude the possibility that the relevant features can also be present plurally. Similarly, the expression “unit” does not preclude this consisting of a plurality of components which can possibly also be spatially distributed.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An integrated chip-based communication system, comprising:
a plurality of source ports and a plurality of destination ports; and
a crossbar or an interconnect, configured to
ascertain, based upon an address matrix of an address header of a data packet received from one of the plurality of source ports, one or more destination ports as receivers of the data packet and transmit the data packet to the receivers ascertained, and
ascertain a readiness to receive at least one of the receivers and design data transfer as a function of the readiness to receive ascertained.

2. The integrated chip-based communication system of claim 1, wherein the crossbar or the interconnect is configured to design the data transfer as a function of the readiness to receive ascertained, such that, in an event that at least one destination port of the plurality of destination ports is not ready to receive, transfer of the received data packet is suspended.

3. The integrated chip-based communication system of claim 2, wherein the crossbar or the interconnect is configured to also suspend the transfer of the received data packet to the destination ports, of the plurality of destination ports, that are ready to receive, and to only resume the transfer when all destination ports of the plurality of destination ports, are ready to receive again.

4. The integrated chip-based communication system of claim 2, wherein the crossbar or the interconnect is configured to continue the transfer of the received data packet to the destination ports, of the plurality of destination ports, that are ready to receive.

5. The integrated chip-based communication system of claim 1, wherein the crossbar or the interconnect is configured to transmit a data packet to a plurality of destination ports, of the plurality of destination ports, simultaneously in real-time communication.

6. A medical imaging facility, comprising:
a scanning device to acquire raw data of a patient;
a control facility to actuate the scanning device; and
the integrated chip-based communication system of claim 1.

7. The medical imaging facility of claim 6, further comprising at least one of:
a magnetic resonance tomography system,
a computed tomography system.

8. A data transfer method for transferring data packets between a plurality of source ports and a plurality of destination ports via a crossbar or an interconnect, the data transfer method comprising:
ascertaining, based upon an address matrix of an address header of a data packet received from one of the source ports of the plurality of source ports, one or more destination ports of the a plurality of destination ports, as receivers of the data packet; and
transmitting the data packet to the receivers ascertained; and
ascertaining a readiness to receive of at least one of the receivers; and
designing data transfer as a function of the readiness to receive ascertained.

9. The integrated chip-based communication system of claim 2, wherein the crossbar or the interconnect is configured to transmit a data packet to a plurality of destination ports, of the plurality of destination ports, simultaneously in real-time communication.

10. The integrated chip-based communication system of claim 3, wherein the crossbar or the interconnect is configured to transmit a data packet to a plurality of destination ports, of the plurality of destination ports, simultaneously in real-time communication.

11. The integrated chip-based communication system of claim 4, wherein the crossbar or the interconnect is configured to transmit a data packet to a plurality of destination ports, of the plurality of destination ports, simultaneously in real-time communication.

12. A medical imaging facility, comprising:
a scanning device to acquire raw data of a patient;
a control facility to actuate the scanning device; and
the integrated chip-based communication system of claim 2.

13. The medical imaging facility of claim 12, further comprising at least one of:
a magnetic resonance tomography system,
a computed tomography system.

14. A medical imaging facility, comprising:
a scanning device to acquire raw data of a patient;
a control facility to actuate the scanning device; and
the integrated chip-based communication system of claim 3.

15. The medical imaging facility of claim 14, further comprising at least one of:
a magnetic resonance tomography system,
a computed tomography system.

16. A medical imaging facility, comprising:
a scanning device to acquire raw data of a patient;
a control facility to actuate the scanning device; and
the integrated chip-based communication system of claim 4.

17. The medical imaging facility of claim 16, further comprising at least one of:
a magnetic resonance tomography system,
a computed tomography system.
